(19) United States
(12) Patent Application Publication
(10) Pub. No.: US 2001/0051247 A1
(43) Pub. Date: Dec. 13, 2001

(54) Plastic article having flame retardant properties

(76) Inventors: Phillip A. Waitkus, Sheboygan, WI (US); Theodore N. Morrison, Sheboygan, WI (US)

Correspondence Address: QUARLES & BRADY LLP, 411 E. WISCONSIN AVENUE, SUITE 2040, MILWAUKEE, WI, 53202-4497, US

(21) Appl. No.: 09/828,008

(22) Filed: Apr. 6, 2001

Related U.S. Application Data
(60) Provisional application No. 60/195,395, filed on Apr. 7, 2000.

(51) Int. Cl. B32B 27/42

(52) U.S. Cl. 428/76; 428/506; 428/522; 156/335; 428/412; 428/477.4

(57) ABSTRACT

A flame retardant article produced by forming a thermoplastic material around at least a portion of a core of partially cured phenolic resin is disclosed. The article has reduced flammability and improved dimensional stability when exposed to flame compared to an article consisting solely of the thermoplastic material. By positioning the thermoplastic between the core and at least all surfaces of the article which may become directly exposed to fire or heat when the article is in use, it is possible to impart the flexibility, colorability and impact resistance characteristics of thermoplastic materials to the article. At the same time, the inner core of the phenolic resin reduces the flammability and improves the dimensional stability of the article when the article is exposed to flame.

### CROSS-REFERENCE TO RELATED APPLICATION

This application claims priority from U.S. Provisional Patent Application No. 60/195,395 filed Apr. 7, 2000.

### BACKGROUND OF THE INVENTION

1. Field of the Invention

This invention relates to a plastic article having a thermoplastic layer fused to a cured phenolic resin inner core that improves the dimensional stability of the article and reduces the flammability of the article when the article is exposed to flame.

2. Description of the Related Art

Plastic extrusions, pultrusions, and moldings, and in particular thermoplastic extrusions, pultrusions, and moldings, have certain advantageous properties and therefore, have achieved widespread use in manufactured goods. For example, thermoplastic extrusions, pultrusions, and moldings are desirable from the standpoint of production efficiency, low cost, and physical properties.

While these and other advantageous properties have led to the widespread use of thermoplastic extrusions, pultrusions, and moldings, there are certain disadvantages with the use of thermoplastic extrusions, pultrusions, and moldings. For instance, when thermoplastic extrusions, pultrusions, or moldings are exposed to temperatures above their melting points, they become dimensionally unstable and may rapidly shrivel and distort into unrecognizable shapes which are no longer self-supporting. Shrinkage or perforation of the molding also exposes the interior of the structure to heat and/or flame. If these high temperature occurrences are accompanied by open flame, the thermoplastic extrusions, pultrusions, or moldings may catch fire. This is undesirable in areas where large numbers of people are to be found or sensitive equipment is located.

Accordingly, there has been an increasing market demand for fire resistant or flame retardant thermoplastic articles, and various techniques have been developed to impart flame retardancy or fire resistancy to plastic articles. These techniques are based on the knowledge that certain materials are not combustible and/or are capable on their own or in combination with other compounds to impart flame retardant or fire resistant properties to plastic articles. As used herein, the terms ‘fire resistant’ and ‘flame retardant’ are used interchangeably. A material is fire resistant or flame retardant when the material has been treated or modified to show reduced combustion rate compared to the corresponding non-treated or non-modified material.

A typical method to impart fire resistant or flame retardant properties to thermoplastic articles involves the manufacture of the articles from plastic materials which have inherent fire resistant and flame retardant properties. For example, such fire resistant and flame retardant plastic materials may contain halogen atoms or various other functional groups which provide fire resistant and flame retardant properties to the plastic material. The most widely used fire resistant and flame retardant plastic material is polyvinyl chloride. Non-halogen containing inherent fire resistant and flame retardant plastic materials have, for various reasons, not gained widespread application.

Another method to render plastic articles flame retardant involves preparing the articles from a mixture of a flammable plastic material and a flame retardant agent (e.g., a filler) or coating a flammable plastic material with a flame retardant agent. Some known flame retardant agents include halogenated compounds, phosphorus containing compounds, metal derivatives, and phenolic resins (see, for example, U.S. Pat. Nos. 6,100,559, 5,383,994, 4,595,710, 4,168,365, 4,107,127, 4,105,825 and 3,598,771). The phenolic resins have proven to be quite beneficial as flame resistant and flame retardant agents because of their cost effectiveness and relative ease of manufacture.

While the above methods have proven to be beneficial in rendering plastic articles flame retardant, there are certain disadvantages with these methods. For instance, the manufacture of articles from plastic materials which have inherent fire resistant and flame retardant properties does not guarantee that the articles will hold up when subjected to heat and flame. As detailed above, polyvinyl chloride is a chlorinated resin which, because of the chlorine content, is self-extinguishing. However, this non-combustibility does not impart a guarantee that polyvinyl chloride parts will not melt and sag under the influence of heat and flame. In addition, it has been demonstrated that polyvinyl chloride parts coated with a flame retardant agent can actually melt out from under the coating of flame retardant agent leaving the same situation as before any coating was applied to the surface of the polyvinyl chloride parts. Therefore, while the polyvinyl chloride parts or polyvinyl chloride parts coated with a flame retardant agent do provide fire resistance, they may not provide dimensional stability at elevated temperatures or when subjected to flame.

Furthermore, it may be difficult to prepare fire resistant and flame retardant articles having a coating of a fire resistant and flame retardant agent on a plastic substrate. Specifically, certain known flame retardant agents, such as the phenolic resins described above, may not provide for an optimum fire resistant coating on all types of thermoplastic substrates. For example, phenolic coatings may not readily stick to a thermoplastic substrate such as polyvinyl chloride. Also, phenolic resins may darken when exposed to light and air making light colored systems impossible. In addition, it may be difficult to produce a smooth coating of a phenolic resin on a thermoplastic substrate, such as polyvinyl chloride, because the surface energy of the thermoplastic substrate and the phenolic resin may be very different. As a result, the phenolic resin has a strong tendency to bead up on the surface of the thermoplastic substrate.

It may also be difficult to prepare flame retardant articles having a filler of a flame retardant agent in a plastic matrix. For example, an article formed from a mixture of a ground phenolic flame retardant agent and a thermoplastic material has a matrix of thermoplastic surrounding the ground phenolic. Because the continuous matrix is thermoplastic, the thermoplastic can melt from between the thermoset ground phenolic particles allowing the whole article to sag and flow. As a result, while the filled polyvinyl chloride parts do provide fire resistance they may not provide dimensional stability when subjected to flame.

Therefore, even though the manufacture of articles from plastic materials having inherent fire resistant properties (e.g., polyvinyl chloride) has provided one type of flame resistant article and the use of flame retardant agents (e.g., as a filler or a coating) has provided another type of flame resistant article, there remains a continuing need for improvements in flame resistant articles. In particular, there is a continuing need for improved fire resistant thermoplastic articles that are dimensionally stable and have reduced flammability when exposed to flame.

### SUMMARY OF THE INVENTION

It has been discovered that the foregoing need for dimensionally stable and reduced flammability thermoplastic articles is met by an article produced by forming a thermoplastic material around at least a portion of a core of partially cured phenolic resin to fuse the thermoplastic to the core and form the article. The article has reduced flammability and improved dimensional stability when exposed to flame compared to an article consisting solely of the thermoplastic material. By positioning the thermoplastic between the core and at least all surfaces of the article which may become directly exposed to fire or heat when the article is in use, it is possible to impart the flexibility, colorability and impact resistance characteristics of thermoplastic materials to the article. At the same time, the inner core of the phenolic resin reduces the flammability and improves the dimensional stability of the article when the article is exposed to flame.

It is therefore an advantage of the present invention to provide a flame retardant article.

It is another advantage of the present invention to provide a flame retardant article that has improved dimensional stability when heated by a flame.

It is still another advantage of the present invention to provide a flame retardant article that has reduced flammability.

It is still another advantage of the present invention to provide a flame retardant article having the flexibility, colorability and impact resistance characteristics of thermoplastic materials

These and other features, aspects, and advantages of the present invention will become better understood upon consideration of the following detailed description and appended claims.

### DETAILED DESCRIPTION OF THE INVENTION

A procedure for making a flame retardant article in accordance with the invention involves providing a core of partially cured phenolic resin, and forming a thermoplastic material around at least a portion of the core to form the article. An article formed by the procedure comprises a core of a cured phenolic resin and a layer of thermoplastic material fused to the core. The core may exist in a wide variety of forms, such as rods, beams, pipes, sheets, and panels. The core should be coated with the thermoplastic material such that the thermoplastic material is positioned between the core and at least all surfaces of the article which may become directly exposed to fire or heat when the article is in use, and preferably the core is coated with the thermoplastic material on the complete surface of the core. The most appropriate nature and grade of the thermoplastic material and the form and thickness of the core may vary widely from article to article, and can be selected having regard to the intended use of the article. For instance, a well defined phenolic core can be produced having sufficient mass to act as a flame barrier as well as reinforcement.

The outer surface of the article may comprise the thermoplastic material or may alternatively comprise another material, such as a paint. Therefore, when it is stated herein that the thermoplastic material is being positioned between the core and a surface of the article, it should be understood that the surface of the article may comprise another material or the same thermoplastic material itself. In other words, the surface of the material may be the same thermoplastic material and be integral with the thermoplastic material.

The phenolic resin used as the core of an article according to the present invention is a thermosetting resin produced by the condensation of an aromatic alcohol with an aldehyde wherein water is produced as a byproduct. Preferably, the aromatic alcohol is phenol and the aldehyde is formaldehyde, but substituted phenols and higher aldehydes may also be used to produce phenolic resins with specific properties such as reactivity and flexibility. The variety of phenolic resins suitable for use in the invention is quite large as the aldehyde to aromatic alcohol ratio, the reaction temperature and the catalyst selected can be varied.

Phenolic resins fall into two broad classes: resole (single stage) resins and novolac (two stage) resins. Resole resins are typically produced with a phenol, a molar excess of formaldehyde and an alkaline catalyst. The reaction is controlled to create a non-cross-linked resin that is cured by heat without additional catalysts to form a three dimensional cross-linked insoluble, infusible polymer. In contrast, novolac resins are typically produced with formaldehyde, a molar excess of phenol, and an acid catalyst. The reaction produces a thermoplastic polymer that can be melted but will not cross-link upon the application of heat alone. The resulting novolac thermoplastic resin can be cross-linked by the addition of a novolac curing agent. Preferably, the phenolic resin used in the present invention is a phenol-formaldehyde resin, and most preferably is a resole resin.

Reinforcement of the phenolic resin used as the core of an article according to the present invention may be achieved in a conventional manner, for example by means of fibrous materials, such as glass fibers, carbon fibers, mineral fibrous material, plastic fibers, textile fibers or metal filaments. The fibrous material may be used in the form of continuous strands, woven or non-woven or meshed sheets or randomly distributed chopped fibers. The fibrous reinforcement materials may be treated in a known manner to improve adhesion between the fibrous material and the phenolic resin. Example reinforcement materials include glass fibers or cloth, polyester mat, and nylon cloth.

Any thermoplastic that can be formed around a core of partially cured phenolic resin may benefit from the reduced flammability and improved dimensional stability at elevated temperatures produced by the method of the present invention. Non-limiting examples of a thermoplastic material that can be used in the present invention include polyvinyl chloride, polyesters, polystyrene, polypropylene, polyethylene, polyvinylidene chloride, polyvinylidene fluoride, polycarbonates, polysulfones, nylons, polymethyl methacrylate, co-polymers such as styrene-acrylonitrile and styrene-butadiene-acrylonitrile, and mixtures thereof. By positioning the thermoplastic between the core and at least all surfaces of the article which may become directly exposed to fire or heat when the article is in use, it is possible to impart the flexibility, colorability and impact resistance characteristics of thermoplastic materials to the article. At the same time, the inner core of the phenolic resin reduces the flammability and improves the dimensional stability of the article when the article is exposed to flame.

In one example embodiment, the invention is a plastic laminate having flame retardant properties and having improved dimensional stability when exposed to heat and/or flame. The laminate includes a core comprising a fiber reinforced cured resole resin, and a layer of polyvinyl chloride fused to the core. The polyvinyl chloride is positioned between the core and at least all surfaces of the laminate which may become directly exposed to fire or heat when the laminate is in use. Optionally, the polyvinyl chloride comprises all surfaces of the laminate. In the laminate, the core may comprise two or more layers of fiber reinforced cured resole resin, with two or more of the layers having different fiber reinforcement materials and/or resole resins. Optionally, the core may comprise at least one layer of the thermoplastic material surrounded by the fiber reinforced cured resole resin. It can be appreciated that a laminate in accordance with the present invention can include an infinite number of combinations of layers of cured resole resin and layers of thermoplastic material as long as there is a layer of thermoplastic positioned between the core and the surfaces of the laminate which may become directly exposed to fire or heat when the laminate is in use.

A flame retardant laminate according to the invention may be formed as follows. First, a reinforcing material is dipped into a phenolic resin. The phenolic resin impregnated reinforcing material is then partially cured at an elevated temperature. The partially cured phenolic resin impregnated reinforcing material is then inserted between sheets of a thermoplastic material and press molded at an elevated temperature for a period of time to produce a flame retardant laminate. In other versions of the invention, the laminate may be formed by extruding or pultruding the thermoplastic over the partially cured phenolic resin impregnated reinforcing material.

### EXAMPLES

The following examples serve to further illustrate the invention, and are not intended to limit the invention in any way.

### Example 1

### Preparation of Partially Cured Resole Impregnated Reinforcing Materials

First, 8″×5.5″ pieces of reinforcing material were dipped into a laminating resole resin commercially available as Plenco® 11635 resole resin from Plastics Engineering Company, Sheboygan, Wis., USA. This is a resole resin which cures simply by exposing the resin to temperatures in excess of 280° F. The reinforcing material was dipped in the resin, the excess removed with a squeegee and the strips of reinforcing material were hung to dry over night. In the morning, the resole impregnated reinforcing materials were partially cured or B-staged by placing the impregnated reinforcing materials in an oven at 150° C. for 3 minutes.

### Example 2

### Preparation of Partially Cured Resole Impregnated Polyester Mat

A first group of resole impregnated reinforcing materials were prepared using the method of Example 1. The reinforcing material used was a polyester non-woven fiber mat commercially available from Sterling Fibers, Inc. under their designation Sterling Veil #2016. Five samples had the following weights of resin and fiber mat.

| | | Weight of | Weight of | Weight of | |
|---|---|---|---|---|---|
| | | Reinforc- | Wet | Dry | Amount |
| | | ing | Reinforcing | Reinforcing | of |
| Test | Reinforcing | Material | Material and | Material and | Resin |
| No. | Material | (gm.) | Resin (gm.) | Resin (gm.) | (gm.) |
| 2a | Polyester mat | 1.5 | 7.8 | 6.1 | 4.6 |
| 2b | Polyester mat | 1.5 | 8.1 | 6.3 | 4.8 |
| 2c | Polyester mat | 1.4 | 8.3 | 6.6 | 5.2 |
| 2d | Polyester mat | 1.5 | 7.9 | 6.1 | 4.6 |
| 2e | Polyester mat | 1.5 | 8.1 | 6.1 | 4.6 |

### Example 3

### Preparation of Partially Cured Resole Impregnated Polyester Mat

A second group of resole impregnated reinforcing materials were prepared using the method of Example 1. The reinforcing material used was a polyester non-woven fiber mat commercially available from Sterling Fibers, Inc. under their designation Sterling Veil #2540. Five samples had the following weights of resin and fiber mat.

| | | | Weight of | Weight of | |
|---|---|---|---|---|---|
| | | Weight of | Wet | Dry | Amount |
| | | Reinforcing | Reinforcing | Reinforcing | of |
| Test | Reinforcing | Material | Material and | Material and | Resin |
| No. | Material | (gm.) | Resin (gm.) | Resin (gm.) | (gm.) |
| 3a | Polyester | 2.8 | 14.5 | 11.5 | 8.7 |
| | mat | | | | |
| 3b | Polyester | 3.1 | 16.0 | 12.5 | 9.4 |
| | mat | | | | |
| 3c | Polyester | 2.9 | 14.2 | 11.1 | 8.2 |
| | mat | | | | |
| 3d | Polyester | 3.1 | 15.8 | 12.3 | 9.2 |
| | mat | | | | |
| 3e | Polyester | 3.0 | 15.5 | 12.2 | 9.2 |
| | mat | | | | |

### Example 4

### Preparation of Partially Cured Resole Impregnated Glass Mat

A third group of resole impregnated reinforcing materials were prepared using the method of Example 1. The reinforcing material used was an E-glass cloth with a satin weave weighing. Five samples had the following weights of resin and fiber mat.

| | | | Weight of | Weight of | |
|---|---|---|---|---|---|
| | | Weight of | Wet | Dry | Amount |
| | | Reinforcing | Reinforcing | Reinforcing | of |
| Test | Reinforcing | Material | Material and | Material and | Resin |
| No. | Material | (gm.) | Resin (gm.) | Resin (gm.) | (gm.) |
| 4a | Glass mat | 6.4 | 12.4 | 11.1 | 4.7 |
| 4b | Glass mat | 6.2 | 11.7 | 10.8 | 4.6 |
| 4c | Glass mat | 6.5 | 12.1 | 10.9 | 4.4 |
| 4d | Glass mat | 6.4 | 11.4 | 10.5 | 4.1 |
| 4e | Glass mat | 6.2 | 11.2 | 10.4 | 4.2 |

### Example 5

### Preparation and Evaluation of a Flame Retardant Article

Various laminate structures in accordance with the invention were prepared as follows. After the B-staging operation described in Example 1, the impregnated reinforcing materials prepared in Examples 2, 3 and 4 were layered in various arrangements between sheets of commercially available polyvinyl chloride. In Table 1 below, there is a listing of the types of layered structures prepared. The letter “P” stands for the sheet of polyvinyl chloride, and the number represents the partially cured resole impregnated mat used between the polyvinyl chloride sheets. Specifically, “2” represents a partially cured resole impregnated mat as prepared in Example 2 above; “3” represents a partially cured resole impregnated mat as prepared in Example 3 above; and “4” represents a partially cured resole impregnated mat as prepared in Example 4 above. After the impregnated reinforcing materials were layered in various arrangements between the sheets of commercially available polyvinyl chloride, the layered structures were placed in a hydraulic press and molded at the times and temperatures indicated in Table 1 to form laminate structures.

The laminate structures prepared as above were then subjected to flame testing as follows in order to determine the resistance of the laminates to thermally induced dimensional instability. In the test method, a 4.5″ long by 1.75″ wide strip of prepared laminate was clamped at one end over a standard Bunsen burner with the blue flame cone of the burner positioned two inches below the center of the laminate strip. A timer was started and photographs were taken at about 5 second intervals until the strip of laminate sagged into the flame. Some laminates sagged rapidly and completely, while others sagged slowly or not at all. The test was culminated when either the laminate sagged from the horizontal to the vertical position or alternatively, three minutes had elapsed. The sag rate was calculated as the number of inches sagged divided by the duration of the test for that sample. The results are reported in Table 1.

TABLE 1

| | Lami- | Lami- | Lami- | Flame | | Sag |
|---|---|---|---|---|---|---|
| | nating | nating | nating | Exposure | Amount | Rate |
| Laminate | Temp. | Time | Pressure | Duration | of Sag | (in./ |
| Structure | (° F.) | (mins.) | (psi) | (secs.) | (inches) | sec.) |
| P-P-P | 330 | 5 | 2000 | 15 | 3 | 0.20 |
| (Control) | | | | | | |
| P-3-P-3-P | 330 | 5 | 2000 | 12 | 3 | 0.25 |
| P-3-4-P | 330 | 6 | 2500 | 51 | 2 | 0.04 |
| P-2-4-2-P | 330 | 7 | 2500 | 30 | 3 | 0.10 |
| P-3-4-3-P | 330 | 7 | 2500 | 28 | 3 | 0.11 |
| P-4-3-4-P | 330 | 7 | 2500 | 182 | 0.5 | 0.00 |
| P-2-3-P-3-2-P | 330 | 7 | 2500 | 10 | 2.5 | 0.25 |
| P-3-3-P-3-3-P | 330 | 5 | 2000 | 66 | 0.75 | 0.01 |
| P-4-P-4-P-4-P | 330 | 7 | 3000 | 45 | 1.75 | 0.04 |

Upon review of Table 1, it can be seen that sag resistance can be improved greatly by including one or more layers of phenolic impregnated reinforcing material between two layers of thermoplastic, and furthermore, that flame burn-through times can be lengthened dramatically by several orders of magnitude using this technique. The best results were given by resole impregnated glass cloth (4). Thus, it can be seen from Examples 1-5 that an article produced in accordance with the present invention has improved resistance to thermally induced dimensional instability and has reduced flammability.

Although the present invention has been described in detail with reference to certain embodiments, one skilled in the art will appreciate that the present invention can be practiced by other than the described embodiments, which have been presented for purposes of illustration and not of limitation. Therefore, the scope of the appended claims should not be limited to the described embodiments.

What is claimed is:

1. A plastic article having flame retardant properties, the article comprising:
a core of a cured phenolic resin; and
a layer of thermoplastic material fused to the core, the layer of thermoplastic material being positioned between the core and at least all surfaces of the article which may become directly exposed to fire or heat when the article is in use.

2. The article of claim 1 wherein:
the phenolic resin is a phenol-formaldehyde resin.

3. The article of claim 1 wherein:
the phenolic resin is a resole resin.

4. The article of claim 1 wherein:
the thermoplastic material is selected from polyvinyl chloride, polyesters, polystyrene, polypropylene, polyethylene, polyvinylidene chloride, polyvinylidene fluoride, polycarbonates, polysulfones, nylons, polymethyl methacrylate, co-polymers such as styrene-acrylonitrile and styrene-butadiene-acrylonitrile, and mixtures thereof.

5. The article of claim 1 wherein:
the core further comprises a reinforcing material.

6. The article of claim 5 wherein:
the reinforcing material comprises glass fibers.

7. The article of claim 1 wherein:
the thermoplastic material is positioned between the core and all surfaces of the article.

8. The article of claim 1 wherein:
the thermoplastic material is polyvinyl chloride.

9. The article of claim 1 wherein:
the thermoplastic material comprises all surfaces of the article.

10. A plastic laminate having flame retardant properties, the laminate comprising:
a core comprising a fiber reinforced cured resole resin; and
a layer of polyvinyl chloride fused to the core, the polyvinyl chloride being positioned between the core and at least all surfaces of the laminate which may become directly exposed to fire or heat when the laminate is in use.

11. The laminate of claim 10 wherein:
the core comprises more than one layer of fiber reinforced cured resole resin, at least two of the layers having different fiber reinforcement materials.

12. The laminate of claim 10 wherein:
the core comprises at least one layer of a thermoplastic material surrounded by the fiber reinforced cured resole resin.

13. The laminate of claim 10 wherein:
the polyvinyl chloride comprises all surfaces of the laminate.

14. A method for producing a thermoplastic article having reduced flammability and having improved dimensional stability when exposed to flame, the method comprising:
providing a core of partially cured phenolic resin;
forming a thermoplastic material around at least a portion of the core to form the article,
whereby the article has reduced flammability and improved dimensional stability when exposed to flame compared to an article consisting of the thermoplastic material.

15. The method of claim 14 wherein:
the phenolic resin is a phenol-formaldehyde resin.

16. The method of claim 14 wherein:
the phenolic resin is a resole resin.

17. The method of claim 14 wherein:
the thermoplastic material is selected from polyvinyl chloride, polyesters, polystyrene, polypropylene, polyethylene, polyvinylidene chloride, polyvinylidene fluoride, polycarbonates, polysulfones, nylons, polymethyl methacrylate, co-polymers such as styrene-acrylonitrile and styrene-butadiene-acrylonitrile, and mixtures thereof.

18. The method of claim 14 wherein:
the thermoplastic material is polyvinyl chloride.

19. The method of claim 14 wherein:
the thermoplastic material is formed around all surfaces of the core.

20. The method of claim 14 wherein:
the core comprises a reinforcing material impregnated with partially cured phenolic resin.

21. The method of claim 14 wherein:
the core comprises a reinforcing material impregnated with partially cured phenolic resin,
the phenolic resin is a resole resin,
the thermoplastic material is polyvinyl chloride, and
the thermoplastic material is molded around all surfaces of the core.

22. The method of claim 14 wherein:
the step of forming the thermoplastic material around at least a portion of the core comprises forming the thermoplastic material by a process selected from molding, extruding and pultruding.
